(19) United States
(12) Patent Application Publication
(10) Pub. No.: US 2011/0013812 A1
(43) Pub. Date: Jan. 20, 2011

(54) ENTRANCE CONTROL SYSTEM HAVING A CAMERA AND CONTROL METHOD THEREOF

(75) Inventors: Yo-shik Shin, Seoul (KR); Geum-yong Kim, Seoul (KR); Young-Hyun Baek, Seoul (KR)

Correspondence Address: STEIN MCEWEN, LLP, 1400 EYE STREET, NW, SUITE 300, WASHINGTON, DC, 20005, US

(73) Assignee: Union Community Co., Ltd., Seoul (KR)

(21) Appl. No.: 12/835,072

(22) Filed: Jul. 13, 2010

(30) Foreign Application Priority Data
Jul. 16, 2009 (KR) 10-2009-0064996

(51) Int. Cl. G06K 9/00

(52) U.S. Cl. 382/118

(57) ABSTRACT

An entrance control system having a camera, and a method thereof of controlling entrance are provided. The entrance control system not only controls entrances through a use of an authentication tool based on biometric recognition, but also photographs a person attempting an entry through the camera, maps the information into authentication history and manages the history data. Accordingly, the entrance control system is capable of rejecting an unauthorized person who has forged biometric information such as a forged fingerprint. In order to ensure a reliability of image record of the person, the system processes a facial recognition algorithm to determine if a frontal face of the person is captured, and controls so that an error message is provided to the person if there is an error, and authentication based on biometric recognition is processed only when the face of the person is captured within an image range.

### CROSS-REFERENCE TO RELATED APPLICATION

This application claims priority from Korean Patent Application No. 10-2009-0064996, filed on Jul. 16, 2009, in the Korean Intellectual Property Office, the disclosure of which is incorporated herein by reference in its entirety.

### BACKGROUND OF THE INVENTION

1. Field of the Invention

The present invention relates to an entrance control system having a camera, which is capable of not only performing entrance control through the use of a biometric recognition-based authentication tool, but also capturing through the camera an image of a person currently attempting an authentication, mapping the captured image into an authentication history, and managing an entrance history and rejecting a person using forged biometric information such as forged fingerprint, based on the authentication history, and a method of controlling an entrance thereof.

2. Description of the Related Art

An entrance control system generally restricts an access to a predetermined space, and controls a built-in or separate door lock to allow an access only to an authorized person. As for the authentication tools used in the entrance control application, there are, mainly, a magnetic card, a contactless wireless authentication card such as radio frequency identification (RFID), or the popular biometric recognition sensor which utilizes fingerprints, eye irises, or faces. Meanwhile, there also is a facial recognition using a camera, but due to its relatively low reliability, it has been considered that there is a limit to apply the facial recognition using a camera for authentication purpose.

Generally, an entrance control system is applicable to not only restricting an access to a certain place, but also managing purpose such as managing employees' work hours, or the like by utilizing the management of the authentication history which is one of the critical functions of the entrance control system.

The authentication history management refers to operations of storing and managing an authentication history about a person every time he attempts authentication through the entrance control system. However, the authentication history management is not perfect. For example, a person A attempting an authentication may be mistakenly led to believe that A is verified successfully by the fact that the door is open, while the authentication was actually failed and the door opening was due to another person B who happened to exit through the door at the time A is attempting the authentication. Due to this problematic area of the authentication history, the entrance control system can not seamlessly control the entrance or manage employees' work hours.

There is another disadvantage. That is, the system may grant an access to an unauthorized person based on a forged authentication tool such as forged fingerprint. Although various authentication algorithms or tools are continuously developed to discern forged fingerprints, more efforts have to be put because fingerprint forgery is also continuously developed.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides an entrance control system having a camera, which is capable of not only performing entrance control through the use of a biometric recognition-based authentication tool, but also capturing an image of a person currently attempting an authentication through the camera, mapping the captured image into an authentication history, and managing an entrance history and rejecting a person using forged biometric information such as forged fingerprint, based on the authentication history, and a method of controlling an entrance thereof.

According to an embodiment of the present invention, a method of entrance control of an entrance control system having an authentication information generating unit to generate authentication information based on biometric recognition and a camera to photograph a person attempting an entry, may include detecting, at the authentication information generating unit, an approach of the person notifying predetermined authentication attempt information to a control unit if determining the approach of the person, and controlling, at the control unit, the camera to photograph the person in accordance with the authentication attempt information, determining, at the control unit, if a frontal face of the person is within an image range, based on an image of the person photographed by the camera, if determining that the frontal face of the person is within the image range, controlling, at the control unit, the authentication information generating unit to generate authentication information regarding the person, and receiving, at the control unit, the authentication information generated by the authentication information generating unit, processing authentication, and storing a result of authentication as history data. The history data may include information of an image file photographed by the camera and stored in a memory, so as to enable access to a corresponding image file along with viewing of a list of history data.

The method of entrance control according to an embodiment of the present invention may additionally include displaying, at the control unit, the person with a guide message regarding a corresponding error, if one of errors occurs from among an error in which the entire or partial frontal face of the person is not captured within the image range, an error in which a back of a head of the person is captured, and an error in which a size of a face contour of the person is not within a predetermined range. Accordingly, the person is guided in a manner his frontal face is properly captured.

According to another embodiment of the present invention, the method may additionally include displaying, at the control unit, a guide message regarding an authentication failure, if the determining and the displaying of the guide message regarding error are reiterated for more than predetermined times or if the error is not resolved until a predetermined time duration elapses since the reception of the authentication attempt information from the authentication information generating unit, and after displaying the guide message regarding the authentication failure, storing in the memory history data based on information regarding a time of making an authentication attempt and an image file photographed by the authentication attempt.

According to yet another embodiment of the present invention, the method may additionally include displaying, at the control unit, a list of history data stored in the memory under the control of a person authorized to control the system, and replaying, at the control unit, the image file mapped into history data selected from the displayed list by the person authorized to control the system, with displaying detailed information about the selected history data.

According to an embodiment of the present invention, an entrance control system may include an authentication information generating unit, a camera to photograph a person attempting an entry, a display unit to output a predetermined guide message to the person, a memory, and a control unit.

The authentication information generating unit may generate authentication information based on biometric recognition, and detect an approach of a person attempting an entry and generate predetermined authentication attempt information if confirming the approach.

The control unit may control the camera to photograph the person, and generate an image file about the person, if receiving the authentication attempt information from the authentication information generating unit.

The control unit may determine if a frontal face of the person is within an image range, based on an image of the person photographed and provided by the camera, if determining that the frontal face of the person is within the image range, controls the authentication information generating unit to generate authentication information regarding the person, processes authentication, and stores a result of authentication as history data into the memory.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 is a block diagram of an entrance control system according to an embodiment of the present invention; and

FIG. 2 is a flowchart provided to explain a method of entrance control of an entrance control system according to an embodiment of the present invention.

### DETAILED DESCRIPTION OF EXEMPLARY EMBODIMENTS

Certain exemplary embodiments of the present invention will now be described in greater detail with reference to the accompanying drawings.

In the following description, same drawing reference numerals are used for the same elements even in different drawings. The matters defined in the description, such as detailed construction and elements, are provided to assist in a comprehensive understanding of the invention. Thus, it is apparent that the exemplary embodiments of the present invention can be carried out without those specifically defined matters. Also, well-known functions or constructions are not described in detail since they would obscure the invention with unnecessary detail.

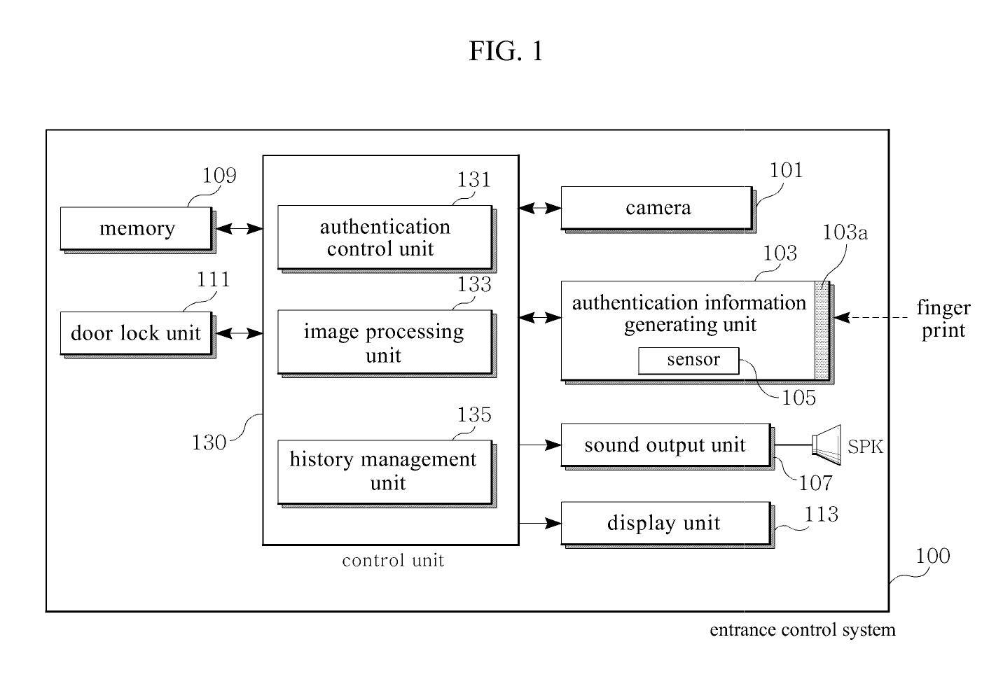

FIG. 1 is a block diagram of an entrance control system according to an embodiment of the present invention.

The entrance control system 100 according to an embodiment of the present invention not only controls entrances (or work hours) of the people attempting to enter a predetermined space, using a biometric recognition-based authentication tool, but also captures images of these people through a camera, maps the captured images into an authentication history, and manages the authentication history to resolve errors related to the processing of an entrance history and to prevent false authentication.

The entrance control system 100 may be formed as a stand-alone system, or a network terminal connected via a predetermined network (not illustrated). If implemented as a network terminal, the entrance control system 100 may utilize a database on an authentication server connected via the network.

The entrance control system 100 may grant entrance to a predetermined space only to authorized personnel based on an authentication processing utilizing not only a contactless radio frequency identification (RFID), but also a biometric recognition technology. The ‘biometric recognition technology’ herein may include a fingerprint recognition, an iris recognition, a vein recognition, or a facial recognition technology. FIG. 1 particularly illustrates an example of applying a fingerprint recognition technology, and an embodiment of the present invention will be explained in detail below with reference to the example of fingerprint recognition illustrated in FIG. 1.

Referring to FIG. 1, the entrance control system 100 according to an embodiment of the present invention may include a camera 101, an authentication information generating unit 103, a sound output unit 107, a memory 109, a door lock unit 111, a display unit 113, and a control unit 130.

The camera 101 captures an image of a person currently attempting an authentication and stores the captured image in the memory 109, under the control of the control unit 130. For example, the image provided by the camera 101 may be based on an image file of the attempting person photographed for a predetermined time period.

The authentication information generating unit 103 may receive an input of authentication information for verifying the person, or generate the authentication information on its own. Depending on an authentication method applied, the authentication information generating unit 103 may be a card reader for contactless authentication card, a fingerprint recognition apparatus, an iris recognition apparatus, or a vein recognition apparatus. Of course, the authentication information processed at the authentication information generating unit 103 varies depending on the authentication method applied. The example explained below employs a fingerprint recognition sensor as the authentication information generating unit 103 which acquires an image of a fingerprint touched on a fingerprint input window 103a using an image sensor (not illustrated). In the example below, the authentication information generating unit 103 acquires a fingerprint image from a contacting fingerprint of the person, and extracts authentication information from the acquired fingerprint image and provides the authentication information to the control unit 130. The authentication information may include minutiae point data extracted from the fingerprint image.

If an attempt for authentication is made, the authentication information generating unit 103 provides the control unit 130 with information about the attempt (hereinbelow, ‘authentication attempt information’). That is, the authentication information generating unit 103 determines that an attempt for authentication is being made, if a fingerprint is contacted against the fingerprint input window 103a and a fingerprint image starts to form in the image sensor (not illustrated). Accordingly, the authentication information generating unit 103 provides the control unit 130 with the ‘authentication attempt information’. The authentication information generating unit 103 may additionally include a separate sensor 105 in the proximity to the fingerprint input window 103a to detect a finger approaching.

The sound output unit 107 may output a predetermined sound signal to a speaker (SPK) under the control of the control unit 130. Through the sound output unit 107, the control unit 130 may deliver the access-attempting person with guide messages regarding authentication steps or ways, or additionally, error messages which will be explained in detail below.

The memory 109 may include various active and inactive memories, and store programs or data of the entrance control system 100. Additionally, the memory 109 may store authentication information about a user previously verified and registered, data regarding a history of authentication processing (history data'), or an image file of the access-attempting person. The authentication information of the registered user may be used for the authentication of the user.

The history data is generated at every event in which an authentication of an attempting person is processed, and herein, the ‘event’ includes a case where there is only an authentication attempt which is followed by no actual authentication processing, and the event where the authentication is processed to fail or succeed. In the case of successful authentication, the history data may include the time of processing authentication and information about the authorized person, while in the case of unsuccessful authentication, the history data may include, basically, the time of processing the authentication processing. Additionally, the history data may include mapping information (such as, a serial number) to map the image file obtained by photographing the attempting person into the history data.

The door lock unit 111 opens or closes a door in accordance with a control signal received from the control unit 130, and may be removably formed on an outer portion of the entrance control system 100.

The display unit 113 may correspond to a liquid crystal display (LCD), or an organic or inorganic electroluminescent display (EL), to visually display the data output from the control unit 130. A person authorized to control the system may view information related to the history of people exiting from the predetermined space, through the display unit 113, and also replay the image file of the people exited the space.

The control unit 130 controls the overall operation of the entrance control system 100. The control unit 130 may include an authentication control unit 131, an image processing unit 133, and a history management unit 135, and control so that a person attempting the authentication is photographed and an image file is generated, concurrently with the authentication processing. Additionally, in response to a request from an authorized person such as a person authorized to control the system, the control unit 130 may cause the display unit 113 to display a list of history data stored in the memory 109, and provide a search function utilizing a conventional search method.

If there is an attempt for authentication of a person, the authentication control unit 131 provides the image processing unit 133 with the ‘authentication attempt information’ and controls the image processing unit 133 to generate an image of the person attempting the authentication. The authentication control unit 131 may directly generate the ‘authentication attempt information’ based on a user's manipulation using a predetermined button (not illustrated), or receive the ‘authentication attempt information’ from the authentication information generating unit 103.

If the authentication control unit 131 receives from the image processing unit 133 ‘attempter detection information’, indicating a detection of a person attempting authentication, the authentication control unit 131 may receive authentication information from the authentication information generating unit 103 and process authentication with respect to the attempting person.

The authentication control unit 131 verifies if the attempting person matches the previously enrolled person, by matching the authentication information (such as minutiae point data of a fingerprint) received from the authentication information generating unit 103 with a plurality of authentication information previously enrolled to the memory 109. If the authentication of the attempting person is successfully processed, the authentication control unit 131 outputs a control signal to the door lock unit 111 to allow the person to enter.

The authentication control unit 131 provides the history management unit 135 with the information about the authentication processing so that the history management unit 135 stores the provided information. As explained above, the history data provides the history management unit 135 not only an event where the authentication is successful, but also an event where the authentication is unsuccessful.

The image processing unit 133 stores an image input from the camera 101 into the memory 109 in the form of an image file, manages the image files, and replays and displays the stored image file of the memory 109 through the display unit 113.

If the ‘authentication attempt information’ is received from the authentication control unit 131, the image processing unit 133 controls the camera 101 to photograph images in front of the entrance control system 100 to capture the image of the attempting person.

The image processing unit 133 processes the images input from the camera 101 since initiation of photographing, determines whether or not a frontal face of the attempting person is within an angle of view, and if not, provides a predetermined error message through the display unit 113 and the sound output unit 107.

A general conventional facial recognition algorithm may be used to determine whether or not the frontal face of the attempting person is within the angle of view. According to the facial recognition algorithm, the image processing unit 133 may be able to recognize not only facial contour, but also eye, noise and mouth contours. If the camera 101 photographs the frontal face of the attempting person, the image processing unit 133 provides the authentication control unit 131 with the ‘attempting person information’.

The image processing unit 133 may not generate the ‘attempting person information’ and output a predetermined error message through the sound output unit 107 and/or the display unit 113, if the face, and eye, noise and mouth contours are not completely recognized. An example of the predetermined error message may include instructions such as ‘Please move to the left,’ or ‘move to the right’, or notification such as ‘Facial recognition failed.’ As a result, the system can prevent access of an intruder who has a forged fingerprint and covers his face with hat or mask.

If the facial area of the image photographed through the camera 101 is not within a predetermined range, the image processing unit 133 may not generate the ‘attempting person information’ and output a predetermined error message through the sound output unit 107 and/or the display unit 113. As a result, the problem of not being able to recognize the attempting person by replaying an image file, which is experienced when the attempting person is not within a predetermined distance to the camera 101, is prevented.

The image processing unit 133 continues photographing for a predetermined time period since the attempt for authentication is initiated until the authentication processing is completed, and continuously maps the photographed images into the history data about the corresponding authentication attempt and stores the information into the memory 109 under the control of the history management unit 135.

The history management unit 135 receives the result of authentication from the authentication control unit 131, stores the received information to the memory 109 and controls the received information. As explained above, the history data may include not only an event of successful authentication, but also an event of unsuccessful authentication, or an event of authentication attempt.

The history management unit 135 controls the history data, while mapping the image file, which is generated and stored to the memory 109 by the image processing unit 133, into the corresponding history data.

By way of example, the history management unit 135 may give a file name to the image file captured through the camera 101, using a predetermined serial number included in the history data, or time of processing the authentication. The history management unit 135 may additionally keep a separate mapping table.

If requested by a person authorized to control the system, the history management unit 135 may provide a list of history data through the display unit 113, and extract a mapping image file of the corresponding history data from the memory 109 if certain data is selected from the provided history data, so that the image processing unit 133 replays the extracted image file.

The components of the entrance control system 100 have been explained so far. The operations of the respective components of the control unit 130 may be implemented in many alternatives. By way of example, the image processing unit 133 may control the image processing unit 133 to process authentication only after the image processing unit 133 receives the ‘authentication attempt information’ of the authentication information generating unit 103 and completes capturing a face of a person attempting to enter.

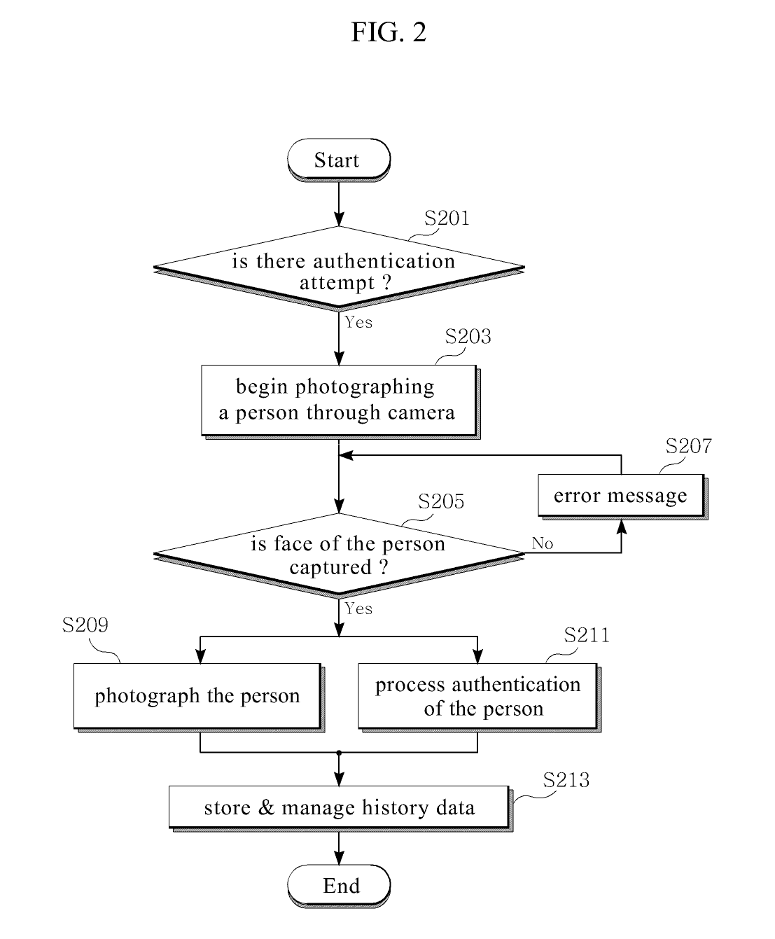

The method of entrance control by the control unit 130 according to an embodiment of the present invention will be explained hereinbelow with reference to FIG. 2. FIG. 2 is a flowchart provided to explain a method of entrance control of the entrance control system according to an embodiment of the present invention.

At S201, the authentication control unit 131 monitors to determine if there is an attempt to gain an entry. The operation at S201 may be initiated by a predetermined button manipulation or by the authentication information generating unit 103 which recognizes a finger contact of a person attempting to enter and provides the authentication attempt information to the authentication control unit 131.

At S203, if there is an attempt for authentication, the authentication control unit 131 provides the image processing unit 133 with the corresponding authentication attempt information, and the image processing unit 133 begins controlling the camera 101 to photograph the person at the gate.

At S205, the image processing unit 133 operates a predetermined facial recognition algorithm based on the image provided by the camera 101 to determine if the frontal face of the person is captured.

If determination at S205 indicates that the frontal face of the person is not captured (such as, if the entire or part of a face is not captured, or only a back of head is captured), or if a size of the captured facial contour is not within a predetermined range (such as, if the person stands too far away from or near to the camera), the image processing unit 133 outputs a guide message for error correction through the sound output unit 107 and/or the display unit 113. At S207, the image processing unit returns to operation at S205 and determines if the frontal face of the person is captured.

If the determination at S205 indicates that the frontal face of the person is captured, at S211, the authentication processing is completed as the image processing unit 133 provides the authentication control unit 131 with the ‘attempting person information’, or the camera 101 keeps photographing the person. Accordingly, the authentication control unit 131 receives authentication information from the authentication information generating unit 103 and processes authenticating the person. Still at S211, the authentication control unit 131 verifies if the person corresponds to the previously-registered person, by matching the authentication information (such as minutiae point data of a fingerprint) received from the authentication information generating unit 103 with a plurality of authentication information previously enrolled in the memory 109.

At S213, the authentication control unit 131 provides the history management unit 135 with the result of authentication, and the history management unit 135 maps the received result of authentication into the image file generated at the image processing unit 133, stores the history information into the memory 109 and manages the information.

The method of entrance control of the entrance control system 100 according to an embodiment of the present invention has been explained. Additionally, if authentication of a person attempting an entry is completed, the authentication control unit 131 may output a control signal to the door lock unit 111 to open for the verified person.

### Examples

If operations at S205 and S207 of FIG. 2 reiterate for more than predetermined times, or the image processing unit 133 did not capture the frontal face of a person within a predetermined time period, the image processing unit 133 may provide the history management unit 135 and the authentication control unit 131 with information regarding a failure of capturing, and the history management unit 135 may generate and manage the history data. In this case, the history data may include a history about error message output, failure of capturing face image, or the like.

Additionally, the authentication control unit 131 may provide a guide message regarding the authentication failure.

As explained above, the history management unit 135 may output a list of history data stored in the memory 109 through the display unit 113, and provide the image processing unit 133 with the detailed information (such as time of making authentication attempt, result of authentication, or information about successfully verified person) of the history data which is selected by the user from the list, together with the image file mapped into the selected history data so that the image file is replayed by the image processing unit 133.

Additionally, since the history data is stored together with the image file even if the authentication or capturing the frontal face of the person is unsuccessful, the data can be utilized for checking, for example, the employees' work hours or fingerprint forgery.

According to an embodiment of the present invention, since image of a person attempting an entry is always recorded through a camera, irrespective of whether the authentication is successful or not, the practically efficient control of access or employees work hours is possible.

Furthermore, since the entrance control system according to an embodiment of the present invention performs face recognition algorithm to determine if a frontal face of the person is captured, and provides the person with guide information if determining an error, reliability of image records increases.

Furthermore, since the entrance control system according to an embodiment of the present invention processes authentication of the person only after capturing the person's facial contour, false authentication, which has incomplete information about the person, is prevented, and good quality image record can be provided to help, for example, more efficient management of employees' work hours.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of entrance control of an entrance control system having an authentication information generating unit to generate authentication information based on biometric recognition and a camera to photograph a person attempting an entry, the method comprising:
detecting, at the authentication information generating unit, an approach of the person notifying predetermined authentication attempt information to a control unit if determining the approach of the person, and controlling, at the control unit, the camera to photograph the person in accordance with the authentication attempt information;
determining, at the control unit, if a frontal face of the person is within an image range, based on an image of the person photographed by the camera;
if determining that the frontal face of the person is within the image range, controlling, at the control unit, the authentication information generating unit to generate authentication information regarding the person; and
receiving, at the control unit, the authentication information generated by the authentication information generating unit, processing authentication, and storing a result of authentication as history data, in which the history data comprises information of an image file photographed by the camera and stored in a memory.

2. The method of claim 1, depending on the result of determination, further comprising displaying, at the control unit, the person with a guide message regarding a corresponding error, if one of errors occurs from among an error in which the entire or partial frontal face of the person is not captured within the image range, an error in which a back of a head of the person is captured, and an error in which a size of a face contour of the person is not within a predetermined range.

3. The method of claim 2, further comprising:
displaying, at the control unit, a guide message regarding an authentication failure, if the determining and the displaying of the guide message regarding error are reiterated for more than predetermined times or if the error is not resolved until a predetermined time duration elapses since the reception of the authentication attempt information from the authentication information generating unit; and
after displaying the guide message regarding the authentication failure, storing in the memory history data based on information regarding a time of making an authentication attempt and an image file photographed by the authentication attempt.

4. The method of claim 1, further comprising:
displaying, at the control unit, a list of history data stored in the memory under the control of a person authorized to control the system; and
replaying, at the control unit, the image file mapped into history data selected from the displayed list by the person authorized to control the system, with displaying detailed information about the selected history data.

5. An entrance control system, comprising:
an authentication information generating unit to generate authentication information based on biometric recognition, and detect an approach of a person attempting an entry and generate predetermined authentication attempt information if confirming the approach;
a camera to photograph the person;
a display unit to output a predetermined guide message to the person;
a memory; and
a control unit to control the camera to photograph the person, and generate an image file about the person, if receiving the authentication attempt information from the authentication information generating unit, wherein
the control unit determines if a frontal face of the person is within an image range, based on an image of the person photographed and provided by the camera, if determining that the frontal face of the person is within the image range, controls the authentication information generating unit to generate authentication information regarding the person, processes authentication, and stores a result of authentication as history data into the memory, and
the history data comprises information of an image file photographed by the camera and stored into the memory.

6. The entrance control system of claim 5, the control unit displays the person with a guide message regarding a corresponding error through the display unit, if one of errors occurs from among an error in which the entire or partial frontal face of the person is not captured within the image range, an error in which a back of a head of the person is captured, and an error in which a size of a face contour of the person is not within a predetermined range.

7. The entrance control system of claim 6, wherein the control unit displays through the display unit a guide message regarding an authentication failure, if the guide message regarding error are reiteratively displayed for more than predetermined times or if the error is not resolved until a predetermined time duration elapses since the reception of the authentication attempt information from the authentication information generating unit, and stores in the memory history data based on information regarding a time of making an authentication attempt and an image file photographed by the camera.

8. The entrance control system of claim 5, wherein the control unit displays a list of history data stored in the memory through the display unit under the control of a person authorized to control the system, and replays the image file mapped into history data selected from the displayed list by the person authorized to control the system, with displaying detailed information about the selected history data.
